(19) United States
(12) Patent Application Publication
(10) Pub. No.: US 2012/0046157 A1
(43) Pub. Date: Feb. 23, 2012

(54) Particulate Filter And Methods For Filter Strength And Pore Size Modification

(76) Inventors: Yanxia Lu, Painted Post, NY (US); Steven Bolaji Ogunwumi, Painted Post, NY (US); Jianhua Weng, Painted Post, NY (US)

(21) Appl. No.: 12/861,437

(22) Filed: Aug. 23, 2010

(51) Int. Cl. B01J 29/06; B01J 21/06; B05D 3/08

(52) U.S. Cl. 502/60; 427/224; 502/232; 977/775

(57) ABSTRACT

A method for strengthening an extruded catalyst honeycomb filter body, including:
contacting an extruded catalyst honeycomb filter body and a siliceous formulation including at least one siliceous source comprising a silicone emulsion, a silica sol, or a combination thereof;
drying the contacted filter body; and
firing the dried contacted filter body to provide the filter body.

Also disclosed are zeolite-based honeycomb filter articles, including a matrix of walls of: a primary phase material homogeneously distributed throughout the walls, as defined herein.

The entire disclosure of any publication or patent document mentioned herein is incorporated by reference.

### FIELD

The disclosure relates generally to zeolite-based honeycomb bodies, such as for use in engine exhaust systems.

### BACKGROUND

Various methods and devices are known for reducing emissions of engine exhaust, including catalyst supports, or substrates, and filters.

### SUMMARY

The disclosure relates to zeolite-based honeycomb bodies and their manufacture. The zeolite-based honeycomb bodies are particularly useful in applications of engine exhaust filtration, and more particularly to high porosity filters for engine exhaust systems, particularly diesel exhaust systems. The disclosed honeycomb bodies exhibit a high surface area, high porosity, sufficient strength for catalytic applications, and combinations thereof, including a combination of all three properties, while also reducing or eliminating the need for washcoating a high volume of catalyst onto a support. In embodiments, an extruded zeolite-based honeycomb body is provided having one or more improved properties, such as porosity, thermal and mechanical properties, particularly under conditions encountered in engine exhaust systems, such as diesel, use and manufacture.

### BRIEF DESCRIPTION OF THE DRAWINGS

In embodiments of the disclosure:

FIGS. 1a-1c show images of the pore microstructure of the Extruded Catalyst Filter (ECF) body before (FIG. 1a) and after (FIGS. 1b and 1c) coating treatment with a siliceous formulation (silicone or silica sol).

FIG. 2 shows the increased mean pore size (MPS) achievable using the disclosed honeycomb strengthening process.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

### Definitions

“Porosity,” and like terms generally refer to the total void space in a honeycomb material that can be attributed to the presence of pores and excludes the void space in a honeycomb material attributable to the presence of macroscopic channels or vias of the honeycomb, or the ratio of the pore volume to the total volume of a pulverized solid material, and may be expressed as percent porosity (% P). Porosity, and like aspects of the ceramic bodies, are mentioned in commonly owned and assigned U.S. Pat. No. 6,864,198. Parameters such as d₁₀, d₅₀ and d₉₀ relate to the pore size distribution. The quantity d₅₀ is the median pore size (MPS) based upon pore volume, and is measured in micrometers; thus, d₅₀ is the pore diameter at which 50% of the open porosity of the ceramic has been intruded by mercury (mercury porosimetry.). The quantity d₉₀ is the pore diameter at which 90% of the pore volume is comprised of pores whose diameters are smaller than the value of d₉₀; thus, d₉₀ is equal to the pore diameter at which 10% by volume of the open porosity of the ceramic has been intruded by mercury. The quantity d₁₀ is the pore diameter at which 10% of the pore volume is comprised of pores whose diameters are smaller than the value of d₁₀; thus, d₁₀ is equal to the pore diameter at which 90% by volume of the open porosity of the ceramic has been intruded by mercury. The values of d₁₀ and d₉₀ are also in units of micrometers. The quantity (d₅₀−d₁₀/d₅₀) describes the width of the distribution of pore sizes finer than the median pore size, d₅₀.

“Super additive,” “super addition,” and like terms generally refer to adding additional ingredients or materials to a batch composition or like formulation in excess of, or in addition to, a 100 wt % base inorganics formulation. A base formulation totaling 100 wt % can be, for example, a combination of nano-zeolite in an amount from 20 to 70 weight percent and an inorganic filler material in an amount from 80 to 30 weight percent, and the super additives can be a mixture of pore formers, with or without other super additives, and can be present or added to the batch in, for example, from about 50 to about 300 wt % in addition to the base formulation 100 wt %.

Extruded Catalyst Filter (ECF) body refers to a filter body having a catalyst, that is pre-loaded, that can be prepared with or without having a wash coat treatment.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for making compositions, concentrates, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. The claims appended hereto include equivalents of these “about” quantities.

“Consisting essentially of” in embodiments refers, for example, to a catalytic honeycomb filter article having relatively high porosity and increased strength, to a method of making a catalytic filter article and precursors thereto, devices incorporating the catalytic filter article, and can include the components or steps listed in the claim, plus other components or steps that do not materially affect the basic and novel properties of the compositions, articles, apparatus, or methods of making and use of the disclosure, such as particular reactants, particular additives or ingredients, a particular agents, a particular surface modifier or condition, or like structure, material, or process variable selected. Items that may materially affect the basic properties of the components or steps of the disclosure or that may impart undesirable characteristics to the present disclosure include, for example, an article having significantly reduced porosity, and little or no improvement in strength of the article, that are beyond the values, including intermediate values and ranges, defined and specified herein.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, and like aspects, and ranges thereof, are for illustration only; they do not exclude other defined values or other values within defined ranges. The compositions, apparatus, and methods of the disclosure can include any value or any combination of the values, specific values, more specific values, and preferred values described herein.

In embodiments, the disclosure provides an article, and the article comprises, consists essentially of, or consists of one of a catalytic honeycomb filter body or a zeolite-based honeycomb body having been treated with a siliceous formulation prior to a final firing, as defined herein.

In embodiments, the disclosure provides a method, and the method of making comprises, consists essentially of, or consists of one of: contacting a once-fired extruded catalytic honeycomb filter body and a siliceous formulation comprised of at least one siliceous source comprising a silicone emulsion, a silica sol, or a combination thereof, drying the contacted filter body; and firing the dried contacted filter body. For additional definitions, descriptions, and methods of siliceous formulations, silica materials and related metal oxide materials, see for example, R. K. Iler, The Chemistry of Silica, Wiley-Interscience, 1979.

These and other aspects of the disclosure are illustrated and demonstrated herein.

In embodiments of the disclosed process, a once-fired extruded catalyst filter body can be dipped into a siliceous formulation, dried, and re-fired (second firing). Such a process can be performed prior to plugging and then fired after plugging to reduce the numbers of firing steps. A silicon emulsion or a silica sol can be used as a vehicle for delivering the silica to, for example, the porous wall structure and between the zeolite particles. The process can diminish the porosity of the piece slightly. The process can be further modified to attain a desired silica loading based on the cellular matrix porosity and solid loadings of the siliceous formulation. The active component of the extruded catalytic filter can be made of, for example, submicron (nano-material) crystals or the material can be spray dried to form agglomerates of the nano-crystal. Another method of forming aggregates of these nano-materials can include, for example, an initial extrusion which can be followed by a soft firing with a top soak temperature between about 350 and about 850° C. The lower soak temperature for this initial firing can be advantageous to avoid unnecessary aging of the catalyst due to exposures to higher temperatures. The strengthening effect of the disclosed process can be realized with any of the disclosed routes, process variations, of combinations thereof. The effect of improving the median pore size (MPS) properties is more apparent when zeolite agglomerates are selected.

Potential health and environmental issues have resulted in the regulation of NOx and particulate emissions from mobile and off-road sources. For 2010 and beyond, an after-treatment device is mandated to meet the stringent low level requirements existing both in the US and Europe. In addition to this, OEMs are also faced with the challenge of improving fuel economy on their vehicles.

For diesel and Gasoline Direct Injection (GDI) engines, OEMs are very interested in a compact (space savings), low cost, and efficient after-treatment system that can address the nitrogen oxides (NOx) and particulate material (PM) requirements, and also provide improved fuel economy. A multi-component after-treatment system is the incumbent technology today. However, integrated technology such as the 4-way systems (i.e., removes CO, hydrocarbons, NOx, and particulate matter) and an ammonia-selective reduction of NOx integrated on a filter has been proposed (SAE 2009-01-0274). These solutions offer a compact system which will reduce the weight and potentially the backpressure of the after-treatment system. Together, this would contribute to the fuel economy in addition to mitigating the emissions issue. It is unproven whether such a combined system could provide a low cost system but it appears to be potentially feasible because of the potential catalyst volume reduction. The 4-way systems still suffer from sulfur poisoning issues (JP2001271634, SAE2007010237). The ammonia-SCR integrated filter technology is being tested via the use of high porosity filters (SAE2009-01-0910). These filters required a high volume of catalyst coating and thus have a significant porosity in excess of 60%. This usually causes the body to be a bit weak if it is a cordierite or an aluminum titanate microcracked body. Addition of the catalyst washcoat usually further decreases the filter material strength due to low pH and the process conditions which extend the microcracks. Other challenges associated with a high porosity filter include, for example: higher backpressure upon catalyst loadings; limitation on catalyst loadings to avoid backpressure penalty; potential catalyst erosion issues; non-uniform catalyst coatings that may lead to poor filtration efficiency of the soot, interaction of the catalyst, and, for example, support materials resulting in decreased catalyst performance; and the additional weight of the support material is also a concern with respect to fuel economy.

In commonly owned and assigned U.S. Pat. No. 7,754,638, and US patent application U.S. Ser. No. 61/308,708 a honeycomb filter formed from a zeolite comprised of nano-particles is disclosed that is applicable to particulate material (PM) and NOx reduction. U.S. Pat. No. 7,754,638 mentions a zeolite-based honeycomb body comprising a matrix of walls comprised of: a primary phase material homogeneously distributed throughout the walls and comprising a zeolite having a SiO₂ to Al₂O₃ molar ratio in the range from 5 to 300; and the walls exhibit a porosity of not less than 25% and a median pore diameter as measured by Hg-intrusion of 1 micron or greater.

A significant feature of U.S. Pat. No. 7,754,638 and U.S. Ser. No. 61/308,708 is that the filter and method circumvents the limitations of a post catalyzed high porosity filter material via a washcoat process. However, neither U.S. Pat. No. 7,754,638 nor U.S. Ser. No. 61/308,708 mention how to form an integrated filter body with high strength tolerance to survive the thermal stress of operation and the canning process. The decreased cellular strength is one challenge with an extruded catalyst filter body.

In embodiments, the present disclosure provides methods for significantly increasing the strength of a filter made from zeolites and other nano-catalysts materials. The disclosure also provides a method for improving the median pore size (MPS) of the resulting filter.

In embodiments, the disclosure provides a method for improving the strength of a weak porous cellular ceramic. More particularly this disclosure relates to the post-processing (firing) procedure for strengthening the body of a porous ceramic body. The process significantly enhances the strength of the porous body while having a minimal impact on the porosity. The disclosed treatment process also increases the resolution of pore sizes as defined by mercury porosimetry resulting in a larger MPS after the treatment. The treatment is applicable to high porosity filter applications having a need for strength improvement. The strength improvement can increase the yield or survivability of pieces in the canning process of a high porosity material with a marginal initial strength. Specifically, the process is well suited for a filter made from a nano-catalyst material with a high surface area. Examples of such materials include: zeolites; nano-oxides such as ceria, alumina, titania, zirconia, silica; mixed oxides catalyst such as ceria zirconia, and like materials, or a combination thereof. Such materials, for example, a zeolite, typically have a narrow particle size distribution and a high volume of small particle fines including submicron particles. These materials do not undergo the typical sintering reaction that has been applied to cordierite, aluminum titanate, or silicon carbide based filter materials. Because of the desire to preserve the high surface area and catalytic benefit of these catalyzed extruded zeolite materials, they are typically bonded together with an inorganic binder such as silicone emulsions, silicone resins, aluminum phosphates, clays, alumina, geopolymer, and silica-alumina sols as the major strength producing component.

A first issue is that the additional complexity of the high porosity typically limits the strength of the filter body after extrusion. A second issue is that it can be difficult to achieve a large median pore size due to the high volume of fines (i.e., nano-particles). In embodiments, the disclosed method solves both of these issues resulting in a high strength porous body with a larger mean pore size. Typical increases in MPS as measured by mercury porosimetry is on the order of 5% to 10%, for example, 6.9 microns increased to 7.8 microns (see Table 1), 4.7 microns increased to 5.6 microns (see Table 4; S-1), and like increases. The higher strength increases the mechanical tolerance for rupture failure due to thermal strain, and makes the finished pieces (body) easier to assemble. In embodiments, the disclosed method also improves the handling resistance to, for example, edge chips. The backpressure and catalytic activity of the pieces after the treatment remain adequate and are not significantly impacted. The process also adds additional thermal mass to the filter which will enable the filter to slightly improve the soot mass limit. The soot mass limit is typically the maximum amount of soot the filter can withstand during regeneration without resulting in a thermal stress failure or cracking. This value is typically associated with the volumetric heat capacity of the material. Thus an increase in the filter bulk density would result in a high soot mass limit. In embodiments, the disclosed process also enables the manufacture of thinner wall geometries, such as 42-8 mil, which would otherwise be weaker than thick wall filters.

In embodiments, the disclosure provides a method for making a filter article having improved median pore size properties, such as having increased median pore sizes.

In embodiments, the disclosure provides a method for increasing the strength of a filter article prepared from zeolites and other nano-catalysts materials. The resulting filter article prepared from zeolites and other nano-catalysts materials by the disclosed process can have increased strength by, for example, from about 50% to about greater than 100 percent compared to a control article that was prepared similarly except that it was not treated with the siliceous formulation. In examples where a sample picked up about 18% of silica after the treatment, a strength increase by a factor of almost about 5 times (4.7 actual) was observed compared to the untreated control sample. When the sample was treated to pick up about 6.5% of the silica, a strength increase by a factor of 1.4 was observed compared to the untreated control sample.

In embodiments, the disclosure provides a catalyst filter body comprising a bulk phase comprised of a nano-particulate zeolite and an intra-zeolite particle space comprised of a siliceous formulation residual. Although not limited by theory the residual siliceous material is believed to be substantially concentrated at the boundaries between the zeolite particles or particulate agglomerates.

In embodiments, the disclosure provides a method for filter pore size control, that is, the treatment method can eliminate very small pore sizes, for example, of about one micron diameter and smaller, and provides an filter or like article having a larger mean pore size of about 5 to about 20% relative increase from the untreated sample. The larger or increase in mean pore size can depend on the treatment and siliceous loadings. The mean pore size increase can be, for example, on the order of about 0.3 to about 1 micron.

In embodiments, the disclosure provides a method for strengthening an extruded catalyst honeycomb filter body, comprising:

contacting an extruded catalyst honeycomb filter body and a siliceous formulation comprised of at least one siliceous source such as a silicone emulsion, a silica sol, or a combination thereof;

drying the contacted filter body; and

firing the dried contacted filter body to provide the filter body.

The catalytically active component in the extruded catalyst filter body can be, for example, a nano-particulate zeolite, aggregates of nano-particulate zeolite obtained for example, from reprocessing nano-particulate zeolite materials, or mixtures thereof.

In embodiments, the extruded catalyst filter body can be formed, for example, directly from nano-particulate zeolite particles. In embodiments, the extruded catalyst filter body can be formed, for example, indirectly from aggregates of nano-particulate zeolite by reprocessing once-fired extruded catalyst honeycomb filter material.

In embodiments, the reprocessing of once-fired extruded catalyst honeycomb filter material can be accomplished by, for example, consolidating nano-particulate zeolite particulates into a monolith, such as pressing into a brick or block mold, or a plurality of monoliths, such as spaghetti strands, followed by partial disintegration or physical breakdown of the strands to aggregated nano-particulate zeolite. In embodiments, partial disintegration or breakdown can include, for example, one or more of crushing, grinding, pounding, hammering, milling, rolling, dye extrusion, screw extrusion, and like relatively mild and macroscopic particle or object size reduction methods.

In embodiments, the disclosure provides a method for making an extruded catalyst honeycomb filter body, comprising:

contacting a once-fired extruded catalyst honeycomb filter body and a siliceous formulation comprised of at least one siliceous source comprising a silicone emulsion, a silica sol, or a combination thereof;

drying the contacted filter body; and

firing the dried contacted filter body to provide a twice-fired filter body.

The catalytically active component in the extruded catalyst filter body can be, for example, a nano-particulate zeolite, aggregates of nano-particulate zeolite, or mixtures thereof. The once-fired extruded catalyst filter body can be, for example, a nano-zeolite in an amount of about 20 to about 70 wt %, and an inorganic filler in an amount of about 80 to about 30 wt % based on 100 wt % of the total batch inorganic materials. In embodiments, the method can further comprise a pore former in from about 50 to about 90 wt % by superaddition relative to the total batch inorganic materials. In embodiments, the method can further comprise plugging a portion of the filter channels prior to firing the dried contacted filter body or after firing the dried filter body.

In embodiments, the median pore size (MPS) of the catalyst filter as measured by mercury porosimetry can be, for example, from about 5 to about 10 microns, from about 6 to about 10 microns, including intermediate values and ranges, and greater than from about 5 to about 10 microns.

In embodiments, the strength of the catalytic filter as measured by modulus of rupture can be, for example, from about 100 to about 500 psi. The strength of the resulting honeycomb filter body as measured by modulus of rupture can be, for example, increased by at least 50% compared to a filter not contacted by the siliceous formulation. The resulting strength as measured by modulus of rupture of the catalyst filter can be, for example, at least 150 psi after treatment compared to a filter not contacted by the siliceous formulation.

In embodiments, the disclosure provides an extruded catalyst honeycomb filter body prepared by any of the disclosed methods.

In embodiments, the disclosure provides a method for making a catalytic honeycomb filter body, including, for example:

forming aggregates of at least one nano-material, the nano-material containing at least one catalyst;

extruding the nano-material aggregates to form a green catalytic filter body;

soft-firing the green body with a top soak temperature between 350 and about 850° C.;

contacting the soft-fired extruded catalyst filter body and a siliceous formulation comprised of at least one of a silicon emulsion, a silica sol, or a combination thereof;

drying the contacted filter body; and

firing the dried contacted filter body to provide a twice-fired catalytic filter body.

In embodiments, the disclosure provides a catalyst honeycomb filter body, including, for example: a mixture of inorganic materials comprising a nano-particulate zeolite in an amount of about 20 to about 70 wt %, and an inorganic filler in an amount of about 80 to about 30 wt % based on 100 wt % of the total inorganic materials, and the filter body having a zeolite or zeolite aggregate interstitial silica content of from about 3 to about 20 wt %. The amount of silica from the batch itself can vary from about 20 about 40 wt %, while the interstitial silica, such as on the surface or at the necks of the zeolite particles or zeolite aggregates, can be, for example, at least 3 to 20 wt % after the siliceous treatment.

In embodiments, the disclosure provides a zeolite-based honeycomb body, comprising a matrix of walls comprised of: a primary phase material homogeneously distributed throughout the walls and comprising a zeolite having a SiO₂ to Al₂O₃ relative mole ratio of from 5:1 to 300:1; at least one metal ion catalytic component, an interstitial siliceous component in an amount of about at least 3 to 20 wt %, and the walls have a porosity of not less than 25% and a median pore diameter as measured by Hg-intrusion of 1 micron or greater.

In embodiments, the honeycomb body can have a porosity, for example, of at least 40%. The honeycomb body can have a porosity, for example, from about 40% to about 80%.

In embodiments, the honeycomb body can have a clean pressure drop of, for example, less than about 1.5 Kpa, such as 1.3 Kpa in a 300/8 filter geometry. In embodiments, the honeycomb body can have a soot loaded pressure drop of, for example, less than 6 Kpa such as at least about 3.5 Kpa in a 300/8 filter geometry.

In embodiments, the honeycomb body can have a zeolite loading from about 100 g/L to about 250 g/L.

In embodiments, the zeolite can be selected from, for example, ZSM-5, beta-zeolites, mordenite, Y-zeolites, ultra-stabilized Y-zeolites, aluminum phosphate zeolites, or like zeolites or like materials, and mixtures thereof.

In embodiments, the zeolite selected for the disclosed composition and process can be catalyzed or catalytic, that is, the zeolite includes or incorporates at least one metal or a metal ion. The metal or metal ion inclusion can be accomplished by, for example, impregnation or ion exchange, as disclosed in commonly owned and assigned U.S. Pat. No. 7,745,638. Typical metal loading by impregnation or ion exchange can be, for example, 1 to about 3 wt %. Metal loadings of, for example, about 2 wt % are particularly useful in the bodies prepared in the present disclosure. Samples of zeolite for application includes ZSM-5, Chabazite, Beta, Mordenite, Zeolite Y, and like material, or combinations thereof. Typical metals used with zeolites can include, for example, Fe, Cu, Mn, Ag, Co, Pd, and like metals, or combinations thereof.

The disclosed filter articles prepared by the post-fire strengthening process and the method of making are advantaged by at least one or more of the following:

the process significantly increases the strength of a high porosity cellular body rendering the body mechanically and thermally more durable;

the process is suitable for strengthening the body of a porous extruded particulate filter made from a nano catalyst material, while maintaining much, if not substantially all, of the high porosity;

the process reduces the small pores and thus results in a larger MPS as measured by mercury porosimetry;

the process can be used to control the pore size distribution of the body;

the process increases the resistance to chipping around the edges of the piece;

the process improves the can-ability (place the body in a container or can) and the yields of an extruded catalyst loaded or catalytic filter;

the effect of the preparative process on the backpressure is minimal and acceptable;

the effect of the preparative process on the catalytic activity is marginal and acceptable;

the process increases the thermal mass of the filter which translates into an increased soot mass limit;

the process makes it possible for thinner wall cellular geometries that would otherwise have been too weak to be considered, such as 8-2 mils wall thicknesses; and

the processes can easily be accomplished during the second firing of the filter plugs in an existing manufacturing process.

In embodiments, the web or wall thickness remains relatively constant when compared before and after the siliceous formulation treatment. The siliceous formulation treatment acts primarily on the pores or interstices of the walls resulting in slight reductions in porosity. The siliceous formulation treatment does not substantially change the thickness of the walls. After the filter body is treated with the liquid siliceous formulation and dried it is possible to see that the silica is in the porous regions between the grains of the particles. Thus, although not bound by theory, it is believed that the residual silica is not on the web surface but is instead situated substantially between the particles of zeolite.

In embodiments, the disclosure provides for treating the entire honeycomb and not selected sections or the periphery of the honeycomb.

In embodiments, prior to contacting the honeycomb with the siliceous formulation, the honeycomb can be treated to be a catalyzed-ready body. The SCR activity was evaluated and found not to be severely affected by the siliceous formulation treatment.

The porosity of the resulting twice-fired and the siliceous treated honeycomb is not significantly reduced. The resulting honeycomb is excellent for particulate and like filter applications.

### EXAMPLES

The following examples serve to more fully describe the manner of using the above-described disclosure, as well as to set forth the best modes contemplated for carrying out various aspects of the disclosure. It is understood that these examples do not limit the scope of this disclosure, but rather are presented for illustrative purposes. The working examples further describe how to prepare the porous articles of the disclosure.

Preparation of a green body A green body can be prepared according to U.S. Pat. No. 5,332,703, entitled “Batch Compositions for Cordierite Ceramics,” and U.S. Pat. No. 6,221,308, entitled “Method of Making Fired Bodies,” both assigned to Corning, Inc., and as modified according to the present disclosure.

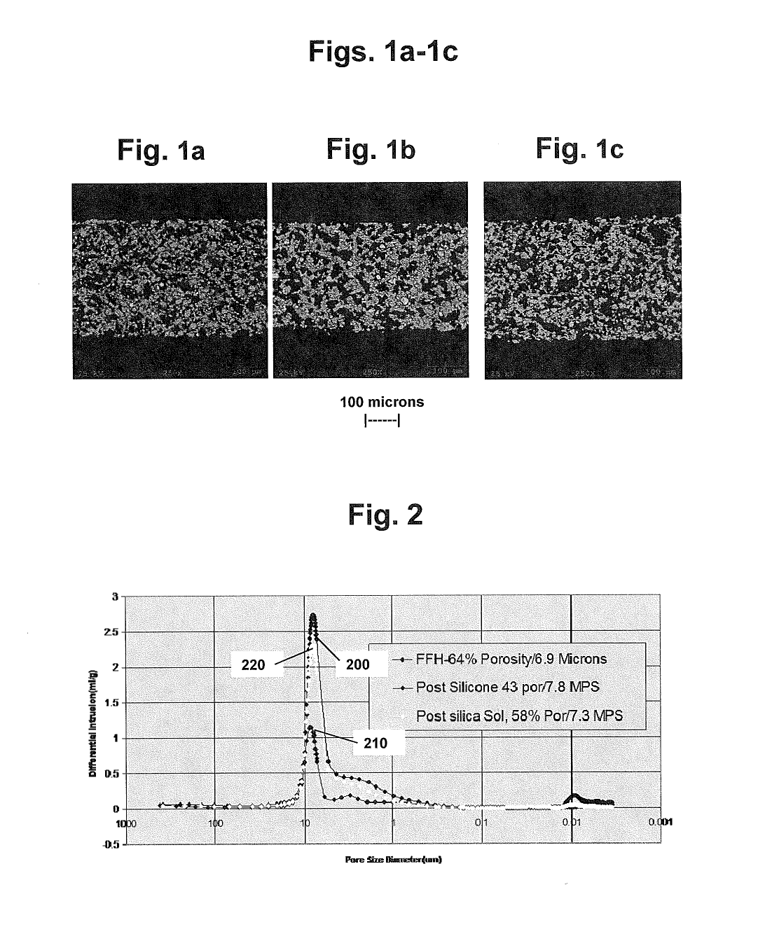

FIGS. 1a to 1c are microstructure images (at 250×) that show the pore structure of Extruded Catalyzed Filter (ECF) before and after coating with siliceous formulations. FIGS. 1a to 1c show a series of microstructures prepared from a nano-zeolite composition. The first microstructure (FIG. 1a) is a composition without a post-extrusion siliceous formulation treatment (as-made control) and was very weak. FIGS. 1b and 1c show, respectively, images of the composition pore structure resulting from silicone and silica sol post-extrusion siliceous formulation treatments.

### Example 1

Siliceous Formulation Treatment—Silicone One exemplary siliceous formulation treatment used 40% silicone emulsion (SILRES M97) as received and the resulting piece shows (FIG. 1b) pronounced evidence of silica from silicone in the microstructure. The treatment increases the initial strength by, for example, more than five times. The siliceous treatment solution used can be, for example, a 50% weight silicone emulsion M97E, which contains about 20% weight silica (based on an analysis of SILRES M 97 E®, from Wacker-Chemie GmbH, Germany In embodiments, typical solid loadings can be, for example, greater than 50 wt %. However, analysis of such samples showed solid loadings equivalent to about 40 wt % presumably due to, for example, settling, polymerization, or both, upon to aging of the silicone emulsion prior to filter treatment.

### Example 2

Siliceous Formulation Treatment—Silica Sol Another exemplary siliceous formulation treatment used a silica sol, which was more dilute than the silicon emulsion (discussed the detailed description above). This silica sol post-treatment increased the strength by more than about two times compared to the untreated samples. The substrate geometry used for the test was a 200/12. The porosity and MOR results are listed in Table 1. The silicone treatment resulted in the decrease of the porosity of from 64% to 43% and the silica sol resulted in a change from the untreated 64% porosity to 58% porosity. The mean pore size increased from the untreated 6.9 microns to 7.8 and 7.3 microns, respectively, for the silicone emulsion and silica sol. The results are shown in FIG. 2 along with the pore size distribution information. FIG. 2 shows the increased mean pore size (MPS) achievable by the disclosed strengthening process where the pore size distribution in microns for the untreated control is shown in trace 200 (64% porosity, mean pore size 6.9 microns), the pore size distribution in microns for the silicon siliceous treated sample is shown in trace 210 (43% porosity, mean pore size 7.8 microns), and the pore size distribution in microns for the silica sol treated sample is shown in trace 220 (58% porosity, mean pore size 7.3 microns).

Silica Sol Preparation. A silica sol can be prepared, for example, as follows: 1) 791.3 grams of 2-methoxyethanol was placed in a beaker and stirred with a magnetic stirrer; 2) 567.4 grams TEOS was added to the 2-methoxyethanol and stirred further; 3) a mixture of 146.75 grams of ethanol and 70 grams of nitric acid was prepared and the mixture was slowly added slowly to the stirred solution; and next 4) 197.25 grams ethanol was added to the stirred solution, capped, and stirred for an additional 16 hrs at 50° C. The weight gained by the pieces after the treatment were:
Post silica sol treatment: 6.5%
Post silicone emulsion M97E treatment: 18%

### Example 3

Filter Body Characterization Table 1 shows how the distribution of the median pore size, porosity, and strength (MOR) can be controlled in the present process. The results also show an increase in bulk density as the result of the siliceous treatment.

TABLE 1

| | % porosity | (d₅₀) | Bulk | (d₅₀ − | MOR (psi) |
|---|---|---|---|---|---|
| Treatment | (% P) | microns | Density | d₁₀)/d₅₀ | strength |
| Control (None) | 63.7 | 6.89 | 0.65 | 0.87 | 78 |
| Silicone | 43.2 | 7.82 | 1.05 | 0.93 | 447 |
| Emulsion | | | | | |
| Silica Sol | 57.8 | 7.26 | 0.77 | 0.78 | 185 |

Table 2 lists the percentage loss in NOx activity of catalytic filter articles of the disclosure as a function of temperature. The NOx conversion before and after coating was essentially unchanged or was affected to only a limited extent, such as less than about 6%.

TABLE 2
Percent Loss in NOx Conversion

| | Temperature (° C.) | | | |
|---|---|---|---|---|
| Siliceous Treatment | 200 | 300 | 400 | 500 |
| Silicone Emulsion | (−)2.91% | (−)5.29% | (−)5.81% | (−)5.72% |
| Silica Sol | (−)2.91% | (−)5.29% | (−)4.47% | (−)2.39% |

Table 3 lists the backpressure data calculated for the control and siliceous treatment samples. The backpressure (dP) was calculated at a flow rate of 26.25 cubic feet per minute (CFM). The increased backpressure calculated after the siliceous treatment is reasonable and within acceptable limits for the soot load. The length and diameter of each filter piece was 15.24 and 14.38 respectively for both samples (300/8 & 200/12) sets tested.

TABLE 3
Extruded Catalyst Filter backpressure.

| | | | | | Clean | |
|---|---|---|---|---|---|---|
| | Plug | Cell | Web | | dP, | Soot Load |
| | depth | Density | Thickness | porosity | Kpa | dP @ 5 g/L, |
| Sample | (mm) | (cpsi) | (mil) | (% P) | model | Kpa model |
| 867 | 7 | 200 | 12 | 63.65 | 1.50 | 5.21 |
| (Control) | | | | | | |
| Silica Sol | 7 | 200 | 12 | 57.81 | 1.49 | 5.22 |
| Silicone | 7 | 200 | 12 | 43.15 | 1.57 | 6.62 |
| Emulsion | | | | | | |
| 867 | 7 | 300 | 8 | 63.65 | 1.32 | 3.58 |
| (Control) | | | | | | |
| Silica Sol | 7 | 300 | 8 | 57.81 | 1.32 | 3.59 |
| Silicone | 7 | 300 | 8 | 43.15 | 1.36 | 4.44 |
| Emulsion | | | | | | |

The control composition (867) contains zeolite that was pre-fired after extrusion and sized to obtain larger agglomerates; the powder is agglomerates of beta-zeolite and fine alumina filler. The disclosed treatment process is effective for strengthening and increasing the MPS of compositions with large zeolite agglomerates. Table 4 shows the effect of the siliceous treatment for different compositions where, for example, wall porosity is reduced and the body strength is increased for all experimental filters.

With a diluted silicone emulsion, the porosity reduction was less than that of the control composition due to lower silica loading. Most of the treated filters had a porosity of about 55% after the treatment, compared to a porosity of about 65% in the untreated original filters. All of the experimental filters were strengthened by about 2.5 to about 5 times after coating. The impact on pore size properties is related to the compositions. The S-1 and S-2 samples in Table 4 are the powders prepared by grinding the pre-fired extruded zeolite (i.e., re-processed), which is a similar treatment to the control composition with the exception of the siliceous treatment. Reprocessing, reforming, consolidating, or like manipulation of the zeolite fines or aggregated zeolite powders results in larger average particle sizes that can provide larger pore sizes and convenient handling. The medium pore size increases about 1 micron compared to untreated samples of the same composition. The other three compositions (S-3, S-4, and S-5) in Table 5 were extruded directly (i.e., regular extrusion) from nano-zeolite powder (as-received) including a micron sized inorganic filler. The pore size remained constant, the porosity was slightly reduced (5-20% reduction), and the strength was increased by from about two to about three fold or more, such as about 80% up to about 300% as measured by modulus of rupture (MOR). The filter's increased strength (MOR) increased the filter's ability to withstand higher stresses, such as during thermal operation and packaging, to prevent, for example, premature mechanical material failure. The strength improvement also increases the resistance of the ware to chipping during handling.

TABLE 4
Siliceous coating effect on ECF with re-processed zeolite.

| Re-Processed | |
|---|---|
| Sample | |
| S-1 | S-2 |

| | Bare | Coated | Bare | Coated |
|---|---|---|---|---|
| Cell# | 200/12 | 200/12 | 300/8 | 300/8 |
| Porosity | 63.1% | 52.0% | 64.6% | 58.7% |
| MPS | 4.7 | 5.6 | 2.6 | 3.41 |
| SA | 257 | — | 293 | 282 |
| MOR | — | — | 35.5 | — |
| Permeability | 0.052 | | 0.074 | 0.065 |
| Density | 0.277 | — | no | — |

TABLE 5
Siliceous coating effect on ECF with direct extrusion of zeolite powder.

| | Direct Extrusion | | | | | |
|---|---|---|---|---|---|---|
| | S-3 | | S-4 | | S-5 | |
| Sample | Bare | Coated | Bare | Coated | Bare | Coated |
| Cell# | 200/12 | 200/12 | 200/12 | 200/12 | 200/12 | 200/12 |
| Porosity | 61.5% | 56.7% | 64.6% | 51.8% | 64.7% | 54.5% |
| MPS | 4.6 | 5.1 | 3.4 | 3.2 | 3.7 | 3.8 |
| SA | 185 | 190 | 200 | 220 | 329 | 329 |
| MOR | 115 | 212 | 56.2 | 210 | 87.6 | 219 |
| Permeability | 0.138 | 0.172 | 0.078 | 0.027 | 0.075 | 0.045 |
| Density | 0.261 | 0.296 | 0.324 | 0.366 | 0.249 | 0.282 |

An exemplary green ware batch composition for an extruded catalyst filter body is listed in Table 6.

The once-fired (pre-fired) batch material as listed in Table 5 includes 67% of a 2% Fe-beta zeolite, 33% alumina, and 50% potato starch as poreformer. The batch was extruded, fired, and ground. After extrusion, the resulting extrudate was dried and fired with a top soak temperature between 600 and 900° C. One recommendation is to use a soak temperature of 600 or 700° C. with enough air to completely remove all the pore formers. A recommended soak temp is of at least 600° C. for at least 3 hrs. Another recommended soak temp is at least 700° C. for at least 5 hrs. Yet another recommended soak temp is at least 800° C. at least 3 to 5 hrs. The resulting cellular (honeycomb) piece can be, for example, dipped coated as described above to achieve the desired solids loading. The material was then fired at about 700 to about 900° C. 800° C. is one particularly useful firing temperature for either the silica sol or the M97 silicone emulsion treatments.

TABLE 6
Representative Batch Composition
for Extruded Catalyst Filter Body

| | | Wt. % |
|---|---|---|
| Inorganics | Fe-Beta (pre-fired & | 80 |
| | sized) −25/+15 | |
| | Fiber - Saffil Alumina | 20 |
| | Running | 100 |
| | Total | |
| Pore former(s) | Wheat Starch | 40 |
| | Running | 140 |
| | Total | |
| Solid binders/organics | Methylcellulose - Culminal | 6 |
| | 724 | |
| | Running | 146 |
| | Total | |
| Liquid additions during | Durasyn 162 | 2 |
| dry blending | Tall Oil | 1 |
| | SILRES M97E ® (silica | 40 |
| | source) | |
| | Total | 189 |
| Other liquid addition(s) | Water | 10-30% |

### Example 4

Direct Extrusion of Nano-Zeolite and Inorganic Fillers The filters made directly from extrusion of nano-zeolite and inorganic fillers, such as silica, were prepared with the composition shown in Table 6. The zeolite content was about 20 to about 50 wt % of total inorganic materials, so the filler content was about 80 to about 50 wt %. All other components were super additions to the inorganic materials. The pore formers (the source of the pores), such as starch, were present in from about 50 to about 90 wt % relative to the inorganic materials.

In embodiments, the disclosed process can include, for example:
1. Mixing of zeolite nano powder and at least one inorganic filler.
2. Extruding the combined inorganic powder and filler mixture with at least one pore former along with all extrusion aids, such as an oil, a surfactant, an inorganic binder, an organic binder, and like ingredients.
3. Extrusion, such as with a twin screw, is a superior mixing method to ensure thorough dispersion of the nano-powders.
4. Microwave drying up to about 90% dry, then dry at about 30 to about 60° C. for 1 to 3 days.
5. Firing up to 850° C. for about 3 hours.
6. After firing the filter channels were plugged at one end of the filter and then non-aligned channels at other end of the filter.

TABLE 7
Compositions for direct extrusion.

| | | S-3 | S-4 | S-5 |
|---|---|---|---|---|
| Inorganics | β-zeolite | 30% | 40% | 60% |
| (100 wt %) | powder as | | | |
| | received | | | |
| | Fused Silica | 70% | 60% | 40% |
| | Tecosil 44C + 6 - | | | |
| | 325 | | | |
| Super | Catalytic ion | 2% | in β- | in β- |
| Additions to | source (iron | | zeolite | zeolite |
| Inorganics | gluconate) (200 | | | |
| | mesh) - | | | |
| | Pore Formers: | 90% | 100% | 90% |
| | cross-linked | | | |
| | corn starch; | | | |
| | wheat starch | | | |
| | Organic Binder | 10% | 10% | 10% |
| | (solid) - | | | |
| | Methylcellulose | | | |
| | siliceous source - | 50% | 50% | 50% |
| | SILRES | | | |
| | M97E Silicon | | | |
| | Emulsion | | | |
| | (liquid) | | | |
| | Oils | 7% | 7% | 7% |
| | (Durasyn 162 | | | |
| | and tall oil) | | | |
| | Water | 33% | 36% | 40% |

The disclosure has been described with reference to various specific embodiments and techniques. However, it should be understood that many variations and modifications are possible while remaining within the spirit and scope of the disclosure.

What is claimed is:

1. A method for strengthening an extruded catalyst honeycomb filter body, comprising:
contacting an extruded catalyst honeycomb filter body and a siliceous formulation comprised of at least one siliceous source comprising a silicone emulsion, a silica sol, or a combination thereof;
drying the contacted filter body; and
firing the dried contacted filter body to provide the strengthened filter body.

2. The method of claim 1 wherein the catalytically active component in the extruded catalyst filter body comprises a nano-particulate zeolite, aggregates of nano-particulate zeolite, or mixtures thereof.

3. The method of claim 1 wherein the extruded catalyst filter body is formed directly from batch or continuous extruding of nano-particulate zeolite particles.

4. The method of claim 1 wherein the extruded catalyst filter body is formed indirectly from aggregates of nano-particulate zeolite by reprocessing a once-fired preformed body, cullet, or an extrudate of nano-particulate zeolite.

5. The method of claim 4 wherein reprocessing the once-fired body of material comprises consolidating nano-particulate zeolite particulates into a monolith or structured body, and partial breakup to aggregated nano-particulate zeolite.

6. The method of claim 1 wherein the extruded catalyst filter body comprises a nano-zeolite in an amount of about 20 to about 70 wt %, and an inorganic filler in an amount of about 80 to about 30 wt % based on 100 wt % of the total batch inorganic materials.

7. The method of claim 6 further comprising a pore former in from about 50 to about 90 wt % by super addition relative to the total batch inorganic materials.

8. The method of claim 1 further comprising plugging a portion of the filter channels prior to firing the dried contacted filter body or after firing the dried filter body.

9. The method of claim 1 wherein the median pore size (MPS) in the walls of the catalyst filter body as measured by mercury porosimetry is from about 4 to about 10 microns.

10. The method of claim 1 wherein the strength of the fired honeycomb filter body as measured by modulus of rupture is from about 100 to about 500 psi.

11. The method of claim 1 wherein the strength of the fired honeycomb filter body as measured by modulus of rupture is increased by at least 50% compared to a filter not contacted by the siliceous formulation.

12. The method of claim 1 wherein the strength of the fired honeycomb filter body as measured by modulus of rupture is at least 150 psi compared to a fired honeycomb filter not contacted by the siliceous formulation.

13. An extruded catalyst honeycomb filter body prepared by the method of claim 1.

14. A method for making a catalytic honeycomb filter body, comprising:
forming aggregates of at least one nano-material, the nano-material containing at least one catalyst;
extruding the nano-material aggregates to form a green catalytic filter body;
soft-firing the green body with a top soak temperature between 350 and about 850° C.;
contacting the soft-fired extruded catalyst filter body and a siliceous formulation comprised of at least one of a silicon emulsion, a silica sol, or a combination thereof;
drying the contacted filter body; and
firing the dried contacted filter body to provide catalytic honeycomb filter body.

15. A catalyst honeycomb filter body, comprising: a mixture of inorganic materials comprising a nano-particulate zeolite in an amount of about 20 to about 70 wt %, and an inorganic filler in an amount of about 80 to about 30 wt % based on 100 wt % of the total inorganic materials, and the filter body having an interstitial silica content of from about 3 to about 20 wt %.

16. A zeolite-based honeycomb body, comprising a matrix of walls comprised of: a primary phase material homogeneously distributed throughout the walls and comprising a zeolite having a SiO₂ to Al₂O₃ molar ratio of from 5 to 300; at least one metal ion catalytic component, an interstitial siliceous component in an amount of about at least 3 to 20 wt %, the walls have a porosity of not less than 25% and a median pore diameter as measured by Hg-intrusion of at least 1 micron.

17. The honeycomb body of claim 16 wherein the porosity is at least 40%.

18. The honeycomb body of claim 16 wherein the porosity is from about 40% to about 80%.

19. The honeycomb body of claim 16 wherein the clean pressure drop is at least about 1.3 Kpa in a 300/8 geometry.

20. The honeycomb body of claim 16 wherein the soot loaded pressure drop is at least about 3.5 Kpa in a 300/8 geometry.
